(19) United States
(12) Patent Application Publication
(10) Pub. No.: US 2012/0105748 A1
(43) Pub. Date: May 3, 2012

(54) PARALLAX BARRIER, THREE DIMENSIONAL DISPLAY AND METHOD OF ADJUSTING PARALLAX BARRIER'S TRANSMITTANCE

(76) Inventors: Shin-Chung Huang, Taipei County (TW); Ching-Hui Ku, Taipei County (TW); Hsiang-Lun Liu, Taoyuan County (TW)

(21) Appl. No.: 13/023,554

(22) Filed: Feb. 9, 2011

(30) Foreign Application Priority Data
Oct. 27, 2010 (TW) 099136727

(51) Int. Cl. G02F 1/1335

(52) U.S. Cl. 349/15; 349/33

(57) ABSTRACT

A parallax barrier includes a first electrode comprising a first sub-electrode and a second sub-electrode. A second electrode is opposed to the first electrode. A plurality of liquid crystal molecules are disposed between the first electrode and the second electrode. A parallax barrier driver provides a voltage difference between the first electrode and the second electrode to form a light-shielding region overlapping with both the first sub-electrode and the second sub-electrode, and forms a transverse electric field between the first sub-electrode and the second sub-electrode. It is noteworthy that the transverse electric field adjusts the rotation angles of the liquid crystal molecules to adjust the width of the light-shielding region, and the parallax barrier's transmittance can thereby be changed.

### BACKGROUND OF THE INVENTION

1. Field of the Invention

The present invention relates to a parallax barrier, a three-dimensional display, and a method of adjusting parallax barrier's transmittance. The present invention especially relate to a parallax barrier having an adjustable transmittance.

2. Description of the Prior Art

Recently, 3D display has developed several different displaying ways for form 3D vision. 3D vision is formed by providing different images to left and right eyes, and the brain will create a convincing 3D effect. Currently, 3D vision has divided into stereoscopic system needs wearing glasses and auto-stereoscopic system. However, it is not convenient and comfortable by wearing the glasses, so the stereoscopic system is gradually replaced by the auto-stereoscopic system.

The auto-stereoscopic system is operated by installing a beam controlling element in front of a display panel. The beam controlling element is generally called “a parallax barrier”, and it controls beams such that different images are seen according to an angle change even at the same position on the beam control element. For example, a 2D/3D liquid crystal display device is equipped by another LCD as a parallax barrier on the display panel.

The parallax barrier is usually disposed between the back light module and the display panel. The on/off of the parallax barrier can be controlled. When the parallax barrier is turned off, the parallax barrier is turned off as well and the parallax barrier becomes transparent so the beam from the back light module can pass through the parallax barrier entirely. When the 3D mode is turned on, the parallax barrier is also turned on and provides different images for right/left eyes and forms 3D vision.

Based on different requirements, the parallax barrier covers different area ratios of the display panel. If the parallax barrier covers too small an area, the transmittance will increase; however, this results in crosstalk. If the parallax barrier covers too large an area, the transmittance will decrease. Generally, in the process of making the parallax barrier, deviations may occur. Therefore, the parallax barrier transmittance is hard to control.

### SUMMARY OF THE INVENTION

In light of the above, the present invention provides a parallax barrier, a three dimensional display thereof, and a method of adjusting parallax barrier's transmittance. The parallax barrier has an adjustable transmittance.

According to a preferred embodiment of the present invention, a parallax barrier comprises: a first electrode comprising a first sub-electrode and a second sub-electrode, a second electrode disposed opposing the first electrode, a plurality of liquid crystal molecules disposed between the first electrode and the second electrode and a parallax barrier driver for providing a voltage difference between the first electrode and the second electrode to form a light-shielding region overlapping with both the first sub-electrode and the second sub-electrode, and to form a transverse electric field between the first sub-electrode and the second sub-electrode, wherein the transverse electric field adjusts the rotation angles of the liquid crystal molecules so as to adjust the width of the light-shielding region.

According to another preferred embodiment of the present invention, a three dimensional display comprises a display unit comprising a light source, where the display unit provides a first image and a second image; a parallax barrier comprising a first electrode comprising a first sub-electrode and a second sub-electrode, a second electrode opposing the first electrode; and a plurality of liquid crystal molecules disposed between the first electrode and the second electrode; and a parallax barrier driver for providing a voltage difference between the first electrode and the second electrode to form a light-shielding region overlapping with both the first sub-electrode and the second sub-electrode, and to form a transverse electric field between the first sub-electrode and the second sub-electrode, wherein the transverse electric field adjusts the rotation angle of the liquid crystal molecules so as to adjust the width of the light-shielding region.

According to another preferred embodiment of the present invention, a method of adjusting parallax barrier's transmittance, comprises: first, a parallax barrier is provided. The parallax barrier comprises: a first electrode comprising a first sub-electrode and a second sub-electrode, a second electrode disposed opposing to the first electrode and a plurality of liquid crystal molecules disposed between the first electrode and the second electrode, wherein when a full dark voltage difference is applied between the first electrode and the second electrode, a first light-shielding region is formed and overlaps with the first sub-electrode and the second sub-electrode, and the parallax barrier has a first transmittance. Then, a voltage difference is provided to the first electrode and the second electrode to form a second light-shielding region overlapping with the first sub-electrode and the second sub-electrode, and to form a transverse electric field between the first sub-electrode and the second sub-electrode, wherein the transverse electric field adjusts the rotation angle of each of the liquid crystal molecules so as to adjust the width of the second light-shielding region and make the parallax barrier have a second transmittance different from the first transmittance.

The transverse electric field between the first sub-electrode and the second sub-electrode adjusts the rotation angle of the liquid crystal molecules, so that the transmittance of the parallax barrier can be increased or decreased without changing the structure of the parallax barrier.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 depicts a three dimensional display of the present invention schematically.

FIG. 2 depicts a three dimensional diagram of a parallax barrier of the present invention schematically.

FIG. 3 depicts a cross sectional view of the parallax barrier taken along line AA′ in FIG. 2.

FIG. 4 depicts a first electrode, a second electrode and panel schematically.

FIG. 5 depicts the parallax barrier applying an operational voltage difference.

FIG. 6 is a flow chart depicting a test of the parallax barrier's transmittance.

FIG. 7 depicts the voltage ratio vs. transmittance.

### DETAILED DESCRIPTION

Certain terms are used throughout the description and following claims to refer to particular components. As one skilled in the art will understand, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . .”

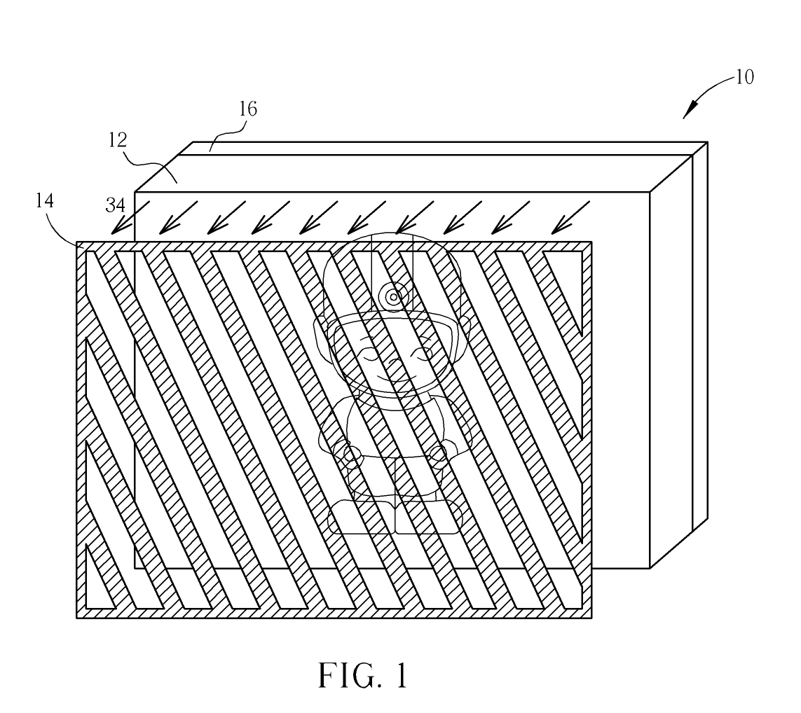

FIG. 1 depicts a three dimensional display of the present invention schematically. As shown in FIG. 1, a three dimensional (3D) display 10 includes a panel 12 and a parallax barrier 14. A back light module 16 is used as a light source of the 3D display 10. When displaying a 3D image, the parallax barrier 14 is turned on, and at least two two-dimensional (2D) images are provided on the panel 12. The 2D images provide light 34. The parallax barrier 14 forms bright and dark stripes, where the stripes can direct light 34 formed by the two 2D images to the right eye and the left eye, respectively, of an observer.

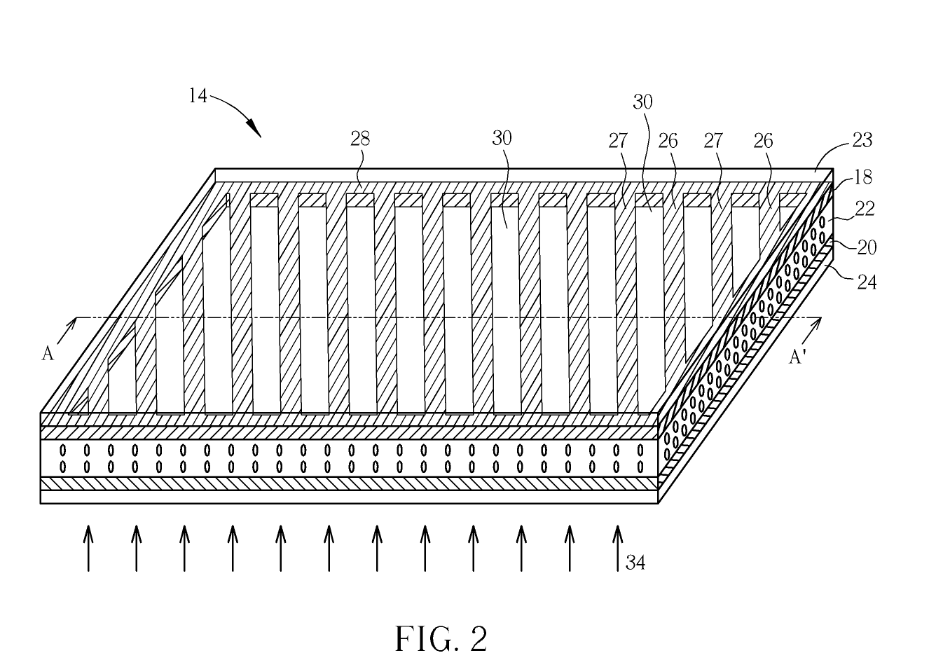

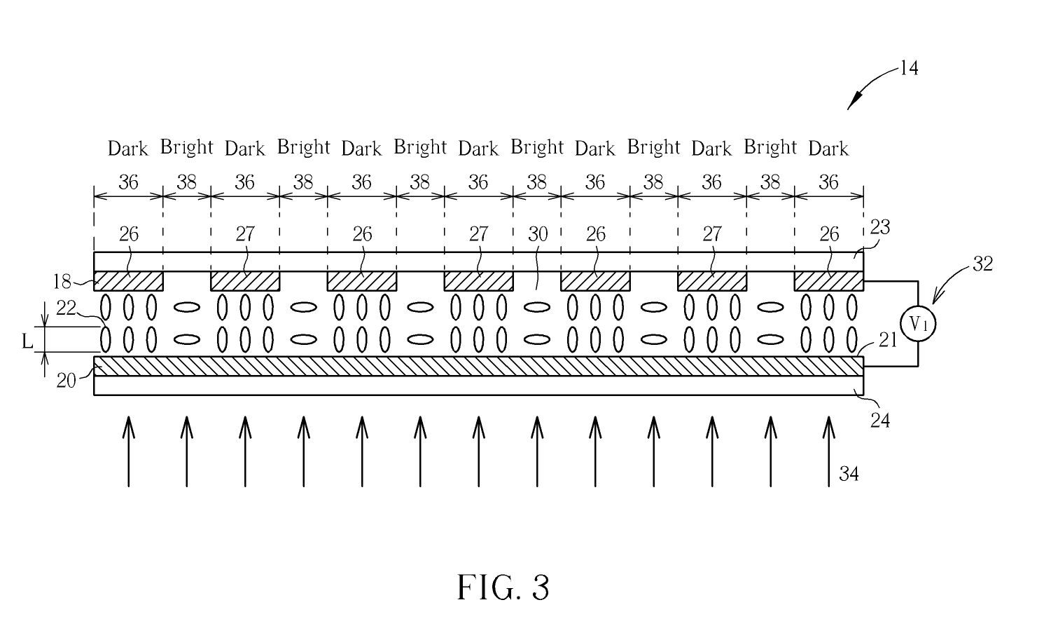

FIG. 2 depicts a three dimensional diagram of a parallax barrier of the present invention schematically. FIG. 3 depicts a cross sectional view of the parallax barrier taken along line AA′, wherein like numbered numerals designate similar or the same parts, regions or elements. As shown in FIGS. 1 to 3, a parallax barrier 14 includes a first electrode 18, a second electrode 20 and numerous liquid crystal molecules 22 disposed between the first electrode 18 and the second electrode 20. The second electrode 20 has a top surface 21 contacting with the liquid crystal molecules 22. Each liquid crystal molecule 22 has a long axis L. In addition, a first polarizing film 23 and a second polarizing film 24 sandwich the first electrode 18 and the second electrode 20. The polarizing directions of the first polarizing film 23 and the second polarizing film 24 are usually perpendicular to each other. Furthermore, the first electrode 18 and the second electrode 20 are made of transparent material. The first electrode 18 includes a lot of striped sub-electrodes. For example, the first electrode 18 includes a first sub-electrode 26 and a second sub-electrode 27 disposed alternatively. A frame 28 connects to two ends of the first sub-electrode 26, and two ends of the second sub-electrode 27. A space 30 is disposed between the first sub-electrode 26 and the second sub-electrode 27. The light 34 provided by the back light module 16 will pass the second polarizing film 24 then enter the parallax barrier 14.

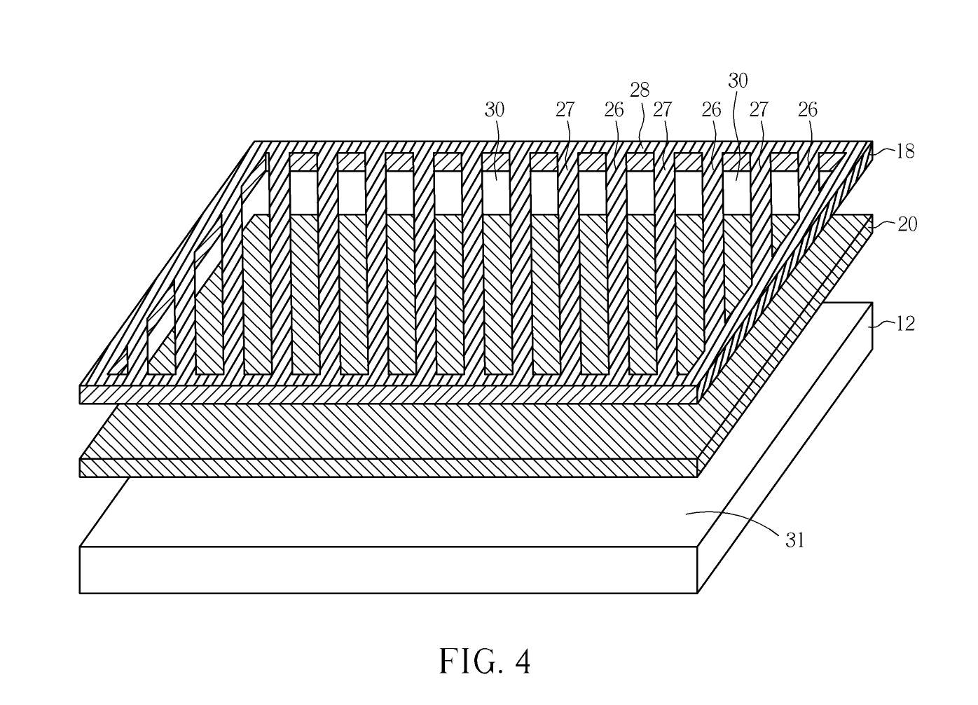

Generally, the widths of the first sub-electrode 26 and the second sub-electrode 27 are the same. However, based on different view points, the widths of the first sub-electrode 26 and the second sub-electrode 27 can be adjusted to become wider or narrower, simultaneously or individually. FIG. 4 depicts a first electrode, a second electrode and panel schematically, wherein like numbered numerals designate similar or the same parts, regions or elements. As shown in FIG. 4, the frame 28 surrounds the display region 31 of the panel 12. The second electrode 20 overlaps with the display region 31 entirely.

Please refer to FIG. 3 and FIG. 1. In order to provide a 3D image with 2 viewpoints or 4 viewpoints, under an ideal circumstance, a full dark voltage difference V₁ is applied between the first electrode 18 and the second electrode 20 to turn on the parallax barrier 14. At this point, a vertical electric field will form between the first sub-electrode 26 and the second electrode 20, and the second sub-electrode 27 and the second electrode 20 so as to make the liquid crystal molecules 22 rotate. Therefore, the direction of the light 34 will be changed by the liquid crystal molecules 22. By the help with the first polarizing film 23 and the second polarizing film 24, a light-shielding region 36 is formed. At this point, it's called a full dark mode of the parallel barrier 14. The light-shielding region 36 is on the first polarizing film 23 at a region where the first sub-electrodes 26, 27 overlaps with the second electrode 20. In other words, the full dark voltage difference V₁ is applied to the first electrode 18 and the second electrode 20. The long axis L of each liquid crystal molecule 22 between the first sub-electrode 26 and the second electrode 20 is perpendicular to the top surface 21 of the second electrode 20. At the same time, the long axis L of each liquid crystal molecule 22 between the second sub-electrode 27 and the second electrode 20 is perpendicular to the top surface 21 of the second electrode 20. A light-penetrating region 38 is formed on the first polarizing film 23, and at a region where the space 30 overlaps with the second electrode 20. The light-penetrating region 38 and the light-shielding region 36 are disposed alternatively so as to form bright stripes and dark stripes. The aforesaid full dark voltage difference V₁ is related to the type of liquid crystal molecules 22. Generally, the full dark voltage difference V₁ is 5V. According to a preferred embodiment of the present invention, when the full dark voltage difference V₁ is applied to the first electrode 18 and the second electrode 20, the long axis L of each liquid crystal molecule 22 between the first sub-electrode 26 and the second electrode 20, and the second sub-electrode 27 and the second electrode 20 is perpendicular to the surface 21 of first sub-electrode 26 and the second sub-electrode 27. After the light 34 shielded by the second polarizing film 24 and the first polarizing film 23, a region where the first polarizing film 23 overlaps with the first sub-electrode 26 and the first polarizing film 23 overlaps with the second sub-electrode 27 forms the full dark mode. The light-shielding region 36 will be overlapping with the first sub-electrode 26, and the second sub-electrode 27. Therefore, part of the light 34 will be blocked by the light-shielding region 36.

Taking a 4 view point 3D display as example, to provide high transmittance and low cross talk, the ideal design of the parallax barrier 14 is that when applying the full dark voltage difference V₁, 25% of the light 34 provided by the back light module 16 can pass through the parallax barrier 14. The remaining 75% of the light 34 will be blocked by the light-shielding region 36. In other words, the parallax barrier 14 transmittance is 25%. Taking the 2 view point 3D display as an example, when applying the full dark voltage difference V₁, 50% of the light 34 provided by the back light module can pass through the parallax barrier 14. The remaining 50% of the light 34 will be blocked by the light-shielding region 36. In other words, the parallax barrier 14 transmittance is 50%.

However, because of the process deviation or other unexpected factors, the parallax barrier's transmittance may be higher than the ideal value when applying the full dark voltage difference V₁. In other words, the width of the light-shielding region 36 is too small. Therefore, crosstalk may happen to the 3D display 10. Sometimes, the width of the light-shielding region 36 is too large, resulting in the brightness of the display not being enough. Taking the 4 view point 3D display as an example, the parallax barrier's transmittance is only 18% when applying the full dark voltage difference V₁, although the ideal value should be 25%. Therefore, the insufficient 7% needs to be compensated by the method provided in the present invention.

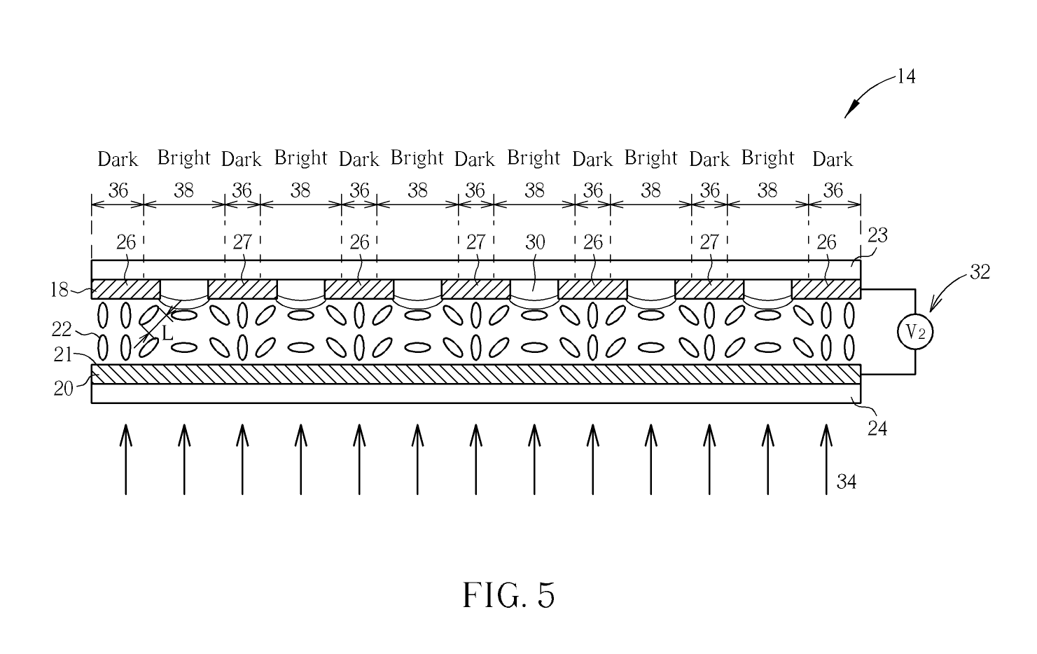

FIG. 5 depicts the parallax barrier applying an operational voltage difference, wherein like numbered numerals designate similar or the same parts, regions or elements. The structure of the parallax barrier in FIG. 5 is the same as that in FIG. 3. As shown in FIG. 5, a parallax barrier 14 includes a first electrode 18, a second electrode 20 and numerous liquid crystal molecules 22 disposed between the first electrode 18 and the second electrode 20. Please refer to FIGS. 3 to 5. The first electrode 18 includes a plurality of striped first sub-electrodes 26 and the second sub-electrode 27. A frame 28 connects two ends of the first sub-electrodes 26 and the second sub-electrode 27. A space 30 is disposed between the first sub-electrodes 26 and the second sub-electrode 27. In addition, a first polarizing film 23 and a second polarizing film 24 sandwiches the first electrode 18 and the second electrode 20.

When the parallax barrier 14 is turned on, a parallax barrier driver 32 provides an operational voltage difference V₂ between the first electrode 18 and the second electrode 20. It is note worthy that an operational voltage difference V₂ is different from the full dark voltage difference V₁, and the operational voltage difference V₂ is smaller than the full dark voltage difference V₁. At this point, a transverse electric field is formed between the first sub-electrode 26 and the second sub-electrode 27 so the liquid crystal molecules 22 near the space 30 are influenced by the transverse electric field so as to change the direction of the long axis L of the liquid crystal molecules 22. Therefore, the long axis L of the liquid crystal molecules 22 near the space 30 will not be perpendicular to the surface of the first sub-electrode 26 or the second sub-electrode 27. Also, the long axis L of the liquid crystal molecules 22 near the space 30 will not be perpendicular to the top surface 21 of the second electrode 20. Therefore, the direction of the light 34 near the edge of the first sub-electrode 26 and the edge of the second sub-electrode 27 is changed. As a result, part of the light 34 near the edge of the first sub-electrode 26 and the edge of the second sub-electrode 27 can pass through the first polarizing film 23 to form a gray scale. The gray scale will be determined as a bright state by a viewer's eyes. At this point, the width of the light-shielding region 36 is smaller than the width of the first sub-electrode 26 and the second sub-electrode 27. The width of the light-penetrating region 38 is increased.

As shown in FIG. 3, by applying the full dark voltage difference V₁ to the parallax barrier 14, the parallax barrier's transmittance is 18%. As described in FIG. 5, by applying the operational voltage difference V₂ to the parallax barrier 14, the parallax barrier's transmittance can be raised to approximately 25% because the transverse electric field changes the direction of the liquid crystal molecules 22 and the width of the light-shielding region 36 becomes smaller than the width of the first sub-electrode 26 and the second sub-electrode 27. Furthermore, when the operational voltage difference V₂ is turned off, the parallax barrier 14 is also turned off. When the operational voltage difference V₂ is turned off, there will be no electric field between the first electrode 18 and the second electrode 20, so the long axis L of each the liquid crystal molecule 22 will be parallel to the top surface 21 of the second electrode 20. At this point, all the light 34 can pass through the liquid crystal molecules 22 without being blocked.

According to a different embodiment, the operational voltage difference V₂ can be higher than the full dark voltage difference V₁ to make the light 34 near the edge of the first sub-electrode 26 and the second sub-electrode 27 unable to pass the first polarizing film 23. Therefore, the width of the light-shielding region 26 will be larger than the width of the first sub-electrode 26 and the width of the second sub-electrode 27. Then, the parallax barrier's transmittance is decreased.

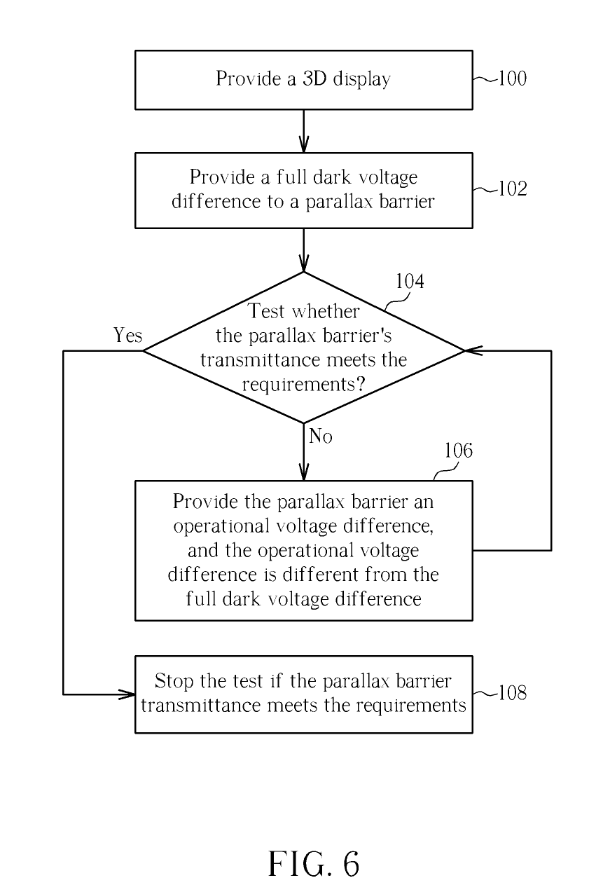

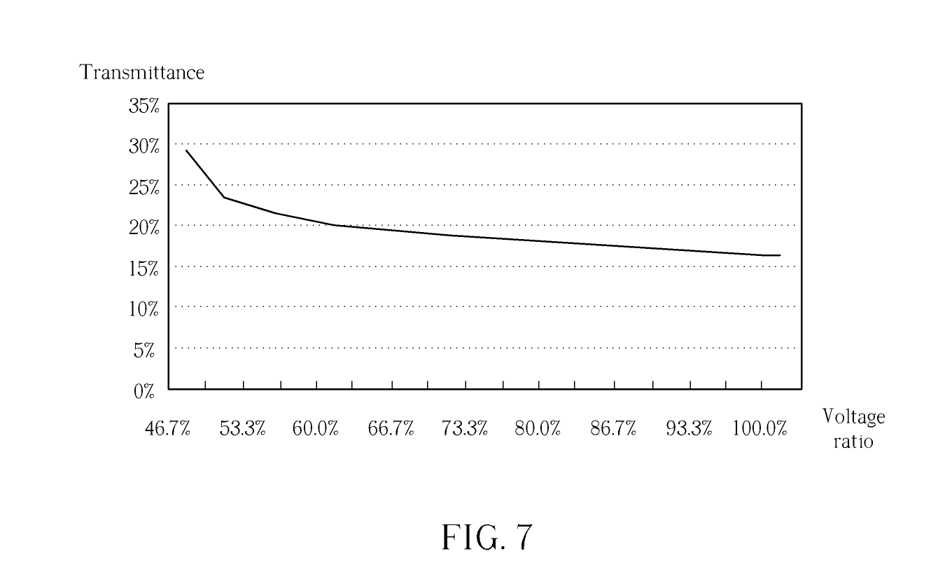

FIG. 6 is a flow chart depicting a test of the parallax barrier's transmittance, wherein like numbered numerals designate similar or the same parts, regions or elements. Please refer to FIGS. 1, 3, 5, and 6. First, in the step 100, a 3D display 10 is provided. Then, in the step 102, a full dark voltage difference V₁ is provided to the parallax barrier 14. In the step 104, the parallax barrier's transmittance is tested to see whether the parallax barrier's transmittance meets the requirements. If the parallax barrier's transmittance meets the requirements, the flow proceeds to the step 108 to finish the test. If the parallax barrier's transmittance does not meet the requirements, then the flow proceeds to the step 106. In the step 106, the operational voltage difference V₂ is applied to the parallax barrier 14. The operational voltage difference V₂ is different from the full dark voltage difference V₁. Then, the step 104 is run again to test whether the parallax barrier's transmittance meets the requirements. If the parallax barrier's transmittance meets the requirements, then the step 108 is run to finish the test. If not, then step 106 and step 104 are repeated until the parallax barrier's transmittance meets the requirements. FIG. 7 depicts the voltage ratio vs. transmittance. The experimental data is the test of a 4-view parallax barrier. The x-axis represents the voltage ratio, and the Y-axis represents the transmittance. The voltage ratio equals the operational voltage difference V₂ divided by the full dark voltage difference V₁ and multiplied by 100%. For example, if the liquid crystal molecules in the parallax barrier have 5V as their full dark voltage difference, when the operational voltage difference V₂ equals 5V, the voltage ratio equals 100%. Then, when the voltage ratio equals is 100%, the transmittance is 18%. But, if the operational voltage difference V₂ equals 3.335V, the voltage ratio equals 66.9%. The transmittance can be raised to 19.5%.

To sum up, the parallax barrier provided in the present invention can finely modulate its transmittance. By changing the operational voltage difference between the first electrode and the second electrode, the transmittance of the parallax can be increased or decreased.

Those skilled in the art will readily observe that numerous modifications and alterations of the device and method may be made while retaining the teachings of the invention.

What is claimed is:

1. A parallax barrier, comprising:
a first electrode comprising a first sub-electrode and a second sub-electrode;
a second electrode disposed opposing the first electrode;
a plurality of liquid crystal molecules disposed between the first electrode and the second electrode; and
a parallax barrier driver for providing a voltage difference between the first electrode and the second electrode to form a light-shielding region overlapping with both the first sub-electrode and the second sub-electrode, and to form a transverse electric field between the first sub-electrode and the second sub-electrode, wherein the transverse electric field adjusts the rotation angles of the liquid crystal molecules so as to adjust the width of the light-shielding region.

2. The parallax barrier of claim 1, wherein the voltage difference is smaller than a full dark voltage difference of each of the liquid crystal molecules.

3. The parallax barrier of claim 2, wherein each of the liquid crystal molecules has a long axis, the second electrode has a top surface contacting with part of the liquid crystal molecules, and when the full dark voltage difference is applied between the first electrode and the second electrode, the long axis of each of the liquid crystal molecules disposed between the first electrode and the second electrode is perpendicular to the top surface.

4. The parallax barrier of claim 1, further comprising a space disposed between the first sub-electrode and the second sub-electrode.

5. The parallax barrier of claim 4, further comprising a light-penetrating region overlapping with the space.

6. The parallax barrier of claim 5, wherein the light-penetrating region and the light-shielding region are disposed alternatively.

7. The parallax barrier of claim 1, wherein when the voltage difference is turned off, the light-shielding region disappears.

8. A three dimensional display, comprising:
a display comprising a light source, where the display provides a first image and a second image; and
a parallax barrier, comprising:
a first electrode comprising a first sub-electrode and a second sub-electrode;
a second electrode opposing the first electrode;
a plurality of liquid crystal molecules disposed between the first electrode and the second electrode; and
a parallax barrier driver for providing a voltage difference between the first electrode and the second electrode to form a light-shielding region overlapping with both the first sub-electrode and the second sub-electrode, and to form a transverse electric field between the first sub-electrode and the second sub-electrode, wherein the transverse electric field adjusts the rotation angles of the liquid crystal molecules so as to adjust the width of the light-shielding region.

9. The three dimensional display of claim 8, wherein the first image and the second image are directed to an observer's right eye and left eye respectively.

10. A method of adjusting parallax barrier's transmittance, comprising:
providing a parallax barrier, comprising:
a first electrode comprising a first sub-electrode and a second sub-electrode;
a second electrode disposed opposing to the first electrode; and
a plurality of liquid crystal molecules disposed between the first electrode and the second electrode, wherein when a full dark voltage difference is applied between the first electrode and the second electrode, a first light-shielding region is formed and overlaps with the first sub-electrode and the second sub-electrode, and the parallax barrier has a first transmittance; and
providing the first electrode and the second electrode a voltage difference to form a second light-shielding region overlapping with the first sub-electrode and the second sub-electrode, and to form a transverse electric field between the first sub-electrode and the second sub-electrode, wherein the transverse electric field adjusts the rotation angle of the liquid crystal molecules so as to adjust the width of the second light-shielding region and make the parallax barrier have a second transmittance different from the first transmittance.

11. The method of adjusting parallax barrier's transmittance of claim 10, wherein the voltage difference is smaller than the full dark voltage difference.

12. The method of adjusting parallax barrier's transmittance of claim 11, wherein the second transmittance is higher than the first transmittance.

13. The method of adjusting parallax barrier's transmittance of claim 11, wherein the width of the second light-shielding region is smaller than the width of the first light-shielding region.

14. The method of adjusting parallax barrier's transmittance of claim 10, wherein when the voltage difference is turned off, the light-shielding region disappears.

15. The method of adjusting parallax barrier's transmittance of claim 10, wherein the voltage difference is higher than the full dark voltage difference.

16. The method of adjusting parallax barrier's transmittance of claim 10, wherein the second transmittance is smaller than the first transmittance.

17. The method of adjusting parallax barrier's transmittance of claim 10, wherein each liquid crystal molecule comprises a long axis, the second electrode comprising a top surface contacts part of the liquid crystal molecules, when the full dark voltage difference is applied between the first electrode and the second electrode, the long axis of each liquid crystal molecule between the first sub-electrode and the second electrode is perpendicular to the top surface of the second electrode.
